(19) United States
(12) Patent Application Publication
(10) Pub. No.: US 2003/0077391 A1
(43) Pub. Date: Apr. 24, 2003

(54) Method for producing anisotropically conductive elastomer using meltable base layer

(76) Inventor: Everett Simons, Mansfield, MA (US)

Correspondence Address: MIRICK O'CONNELL, 1700 WEST PARK DRIVE, WESTBOROUGH, MA, 01581-3941, US

(21) Appl. No.: 10/263,471

(22) Filed: Oct. 2, 2002

Related U.S. Application Data
(60) Provisional application No. 60/326,808, filed on Oct. 2, 2001.

(51) Int. Cl. B05D 5/12; B05D 3/02

(52) U.S. Cl. 427/384; 427/127; 427/598

(57) ABSTRACT

A method for making cured Anisotropic Conductive Elastomer (ACE) material, the ACE comprising a mixture of magnetic conductive particles and an elastomer, wherein uncured ACE material is spread on a carrier and then cured with heat under a magnetic field, the method comprising coating the carrier with a layer of material that is solid when the uncured ACE is applied, but melts at the ACE curing temperature, spreading uncured ACE material on the carrier over the coating, and heating the ACE material to a temperature at least sufficient to melt the coating layer, to allow the conductive particles to protrude into the melted carrier layer.

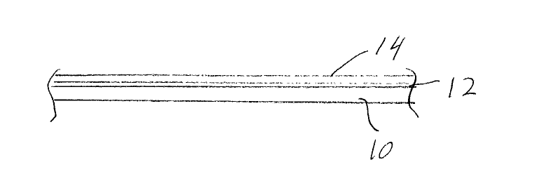

### CROSS-REFERENCE TO RELATED APPLICATION

This application claims priority of provisional application serial No. 60/326,808 filed on Oct. 2, 2001.

### FIELD OF THE INVENTION

This invention relates to a method for producing an anisotropically conductive elastomer material.

### BACKGROUND OF THE INVENTION

Anisotropically Conductive Elastomer (ACE) interconnect material is formed by magnetically aligning fine magnetic particles in sheets of uncured silicone such that the particles form arrays of electrically isolated columns. These columns are frozen in place as the silicone cures. When a layer of this ACE is compressed between two electrical conductors, the particles in the compressed column come into contact with each other and the conductors, forming an electrically conductive path connecting the conductors. Conductivity of the column remains over a compression range which is a function of the material design. This range, often referred to as the material's dynamic range, provides compensation for the lack of co-planarity of the conductors. ACE is thus a flexible, compressible electrical interconnect medium.

Most of the co-planarity compensation comes from the topography that is created on the upper surface of the ACE, since the magnetic force on the particles making up the conductive columns causes the top of the columns to push slightly above the plane formed by the liquid (uncured) silicone. The height of this raised topography is controlled by balancing the magnetic forces that build the column up, against the surface tension forces (slightly augmented by the weight of the particle) that push the top particle in each column down. The amount of allowable topography on the upper surface is limited: if the columns grow well above the surface of the surrounding silicone, they become mechanically unstable protrusions, and their vertical conductivity is compromised.

As devices coupled to ACE warm up, the ACE polymer thermally expands more than the metal particles that form the electrically conductive columns. Initially, the polymer expands into the interstitial spaces between the pads on the device(s), and into the topological voids between the conductive columns of the ACE existing at the surface of the ACE. As the temperature of the polymer rises, so does the amount of thermal expansion. If the expansion fills the topological voids and the temperature continues to rise, additional thermal expansion reduces the mechanical loading force on the (relatively rigid) conductive columns. If the polymer gets too hot and thus expands too much, the reduction in force on the particles in the conductive columns (which are initially compressed along the direction of the electrical path) may cause the resistance to increase beyond acceptable limits.

U.S. Pat. No. 5,045,249 teaches the use of “ . . . an easily penetrable, removable substance such as, e.g., grease or honey . . . ” to pre-coat the carrier sheet for the uncured ACE medium. It also teaches that “ . . . non-adhering substances such as, e.g., rubber or wax may be used to support the medium during magnetic field alignment and curing.” Two experiments using grease coatings are described in the patent.

Coating a carrier sheet with grease or a liquid like honey and then over coating this layer with ACE medium would be impractical in mass production, especially when it is critical to control the thickness of the ACE. The ACE medium must be highly viscous to prevent the high density conductive particles from settling out of suspension before column formation. Thickness control is another problem: coating a viscous liquid, e.g. using a roller, creates pressure gradients and shear (lateral) forces on the substrate being coated. If the surface of the substrate is grease or a thick liquid (e.g. honey), this surface will flow laterally during the process, and can become grossly nonuniform in thickness, thus molding unacceptable variations into the overlying sheet of ACE being formed.

The use of a material whose softness allows columns forming in the matrix to partially penetrate into the underlying carrier seems impractical or impossible. The weight of a column is about one billionth of a pound, and can thus be ignored. The magnetic forces and counter-balancing surface tension forces create local pressures on the order of 1000 Pascals (1% of an atmosphere), which would not significantly press into a solid carrier, whether wax or rubber.

### SUMMARY OF THE INVENTION

The primary goal of the invention is to decrease the preload force required for ACE-based interconnection devices, thereby increasing the maximum operating temperature of the device.

In the invention, a material with a softening or melting point above the temperature at which the uncured ACE mixture is coated, but below the temperature at which the ACE is cured, is first applied to a carrier sheet or other substrate. The coating can either be melted, or dissolved into a suitable solvent, applied in a liquid form, and then solidified. The uncured ACE medium is then applied to the coated carrier, e.g. by pouring the medium onto the carrier and pulling it under a blade, leaving a uniform thickness of ACE medium on the coated carrier. Then the carrier is heated sufficiently to melt the coating material before, during, or soon after applying a magnetic field to form the columns of magnetic particles. The ACE medium is then at least partially cured (polymerized) by this heat while the coating material is in a liquid, a partially liquid, or a gelatinous state. Curing may be accelerated by further increasing the temperature.

The particular meltable coating material is selected to achieve the desired end result given the process conditions. The desired end result is a protrusion of the columns on the side of the ACE that is against the carrier. The selected coating material must be solid, or at least sufficiently rigid, at the temperature at which the uncured ACE material is laid onto the carrier sheet, such that the material does not deform to an extent which would appreciably effect the uniformity of the cured ACE. The material must then melt, or at least soften sufficiently to allow the columns to protrude into the material, at the ACE polymer precure or cure temperature, typically 80-140 C. Preferably, the coating material is a solid at room temperature and a liquid at the ACE polymer curing temperature. A liquid film allows the penetration of the magnetic columns into the film, and also increases lateral column mobility across the magnetic field lines as the columns are formed due to the reduced drag at the ACE/liquid interface as compared to an interface to a solid substance such as an uncoated carrier. The liquid film thickness is preferably at least one-half of the diameter of the particles.

One class of meltable coating materials that has been successfully used is paraffin waxes. These are materials that have sufficient rigidity at room temperature to prevent significant plastic deformation as the uncured ACE medium is being applied to the coated carrier, but that sufficiently melt at processing temperatures so that the local support under conductive columns is typically less than the downward forces applied by the magnetic and surface tension to the magnetic particles forming the conductive columns. It is expected that various coating materials that are hydrocarbons, or mixtures containing at least 50% hydrocarbons with e.g. particulate fillers to adjust the viscosity, will achieve the desired result.

The resulting material is both functionally and visually different from a sheet of ACE produced on a conventional flat solid carrier. Since the electrically conductive columns protrude slightly from both the top and bottom surfaces, it is easier to make initial electrical contact (requires less preload force) when the sheet is compressed between a device and a substrate. This combines with the additional volume created by the topology of the bottom surface (along with the topology from the top surface which exists anyway) to leave more “dead volume” after the device has been assembled. This additional dead volume gives the ACE matrix more room for thermal expansion, thus increasing the maximum usable temperature of the device. This increase is born out by a change in the appearance of the resulting sheet of ACE: the bottom side of an ACE sheet produced on a conventional smooth solid carrier sheet is flat, glossy and reflective, but the bottom side of an ACE sheet produced using a softening or melting coating has a textured or matte appearance.

### BRIEF DESCRIPTION OF THE DRAWING

Other objects, features and advantages will occur to those skilled in the art from the following description of the preferred embodiment and the accompanying drawing, which is a schematic side view of a carrier sheet with a meltable coating layer and uncured ACE material spread thereon ready to be cured.

### DESCRIPTION OF THE PREFERRED EMBODIMENT

The FIGURE schematically depicts carrier sheet 10 with meltable coating layer 12 thereon. A layer of uncured ACE material 14 is on top of layer 12. When this assembly is heated to cure the ACE elastomer, coating 12 melts, which allows the lower particle in each of the columns of particles to protrude slightly from the lower face of ACE 14, similarly to the protrusion that occurs at the unrestrained top face of ACE 14. This protrusion should be at least 10% of the particle diameter. The relatively low resistance of a liquid material 12 to the magnetic force on the lowest particle in each column of particles allows this protrusion to take place. Proper selection of a meltable material and a magnetic field strength will result in magnetic particle protrusion that is sufficient for the purposes described above but not so much as to create column instability at the lower surface of the ACE.

Although specific features of the invention are shown in some drawings and not others, this is for convenience only as some feature may be combined with any or all of the other features in accordance with the invention.

Other embodiments will occur to those skilled in the art and are within the following claims:

What is claimed is:

1. A method for making cured Anisotropic Conductive Elastomer (ACE) material, the ACE comprising a mixture of magnetic conductive particles and an elastomer, wherein uncured ACE material is spread on a carrier and then cured with heat under a magnetic field, the method comprising:
coating the carrier with a layer of material that is solid when the uncured ACE is applied, but melts at the ACE curing temperature;
spreading uncured ACE material on the carrier over the coating; and
heating the ACE material to a temperature at least sufficient to melt the coating layer, to allow the conductive particles to protrude into the melted carrier layer.

2. The method of claim 1 in which the coating material contains at least 50% hydrocarbons.

3. The method of claim 2 in which the coating material comprises a wax.

4. The method of claim 3 in which the coating material comprises paraffin.

5. The method of claim 1 in which the ACE is heated up to a temperature of from about 80 C. to about 140 C., to both melt the carrier and cure the ACE.

6. The method of claim 1 in which the coating material softens sufficiently such that the combined surface tension and magnetic forces on the particles forming the conductive columns is sufficient to allow penetration of the surface of the softened coating by at least 10% of a particle diameter.
